(19) United States
(12) Patent Application Publication
(10) Pub. No.: US 2024/0310625 A1
(43) Pub. Date: Sep. 19, 2024

(54) OPTICAL SCANNING DEVICE AND IMAGE FORMING APPARATUS

(71) Applicant: CANON KABUSHIKI KAISHA, Tokyo (JP)

(72) Inventors: HIROKI KATAYAMA, Shizuoka (JP); TAKU MUROTANI, Shizuoka (JP)

(21) Appl. No.: 18/596,304

(22) Filed: Mar. 5, 2024

(30) Foreign Application Priority Data
Mar. 16, 2023 (JP) 2023-041628

(51) Int. Cl. G02B 26/12; H04N 1/113

(52) U.S. Cl. CPC G02B 26/121; G02B 26/123; H04N 1/113

(57) ABSTRACT

An optical scanning device includes first and second light sources, a rotational polygon mirror reflecting first and second luminous fluxes, and first and second lenses. The polygon mirror reflects the second luminous flux in an opposite direction to the first luminous flux and the second lens is disposed on a side opposite to the first lens as a boundary of the polygon mirror. A shielding member including a shielding wall shielding first and second optical paths from the first and second light sources toward the polygon mirror, respectively. The shielding member is rotatable about a rotating shaft and moves between a shielding position and a retracted position. As viewed in a rotational axis direction of the polygon mirror, the rotating shaft is positioned between the first and second optical paths and an axis of the rotating shaft extends in a direction crossing to an optical axis of the first lens.

### FIELD OF THE INVENTION AND RELATED ART

The present invention relates to an optical scanning device which is mounted on an image forming apparatus such as a copier and a laser beam printer, and to an image forming apparatus on which it is mounted.

Conventionally, as an optical scanning device which is used for a monochrome image forming apparatus which applies an electrophotographic technology, there are some optical scanning devices which include a laser luminous flux shielding member which prevents a laser luminous flux from leaking outside of the optical scanning device. For example, an optical scanning device, which is disclosed in Japanese Laid-Open Patent Application (JP-A) Hei 11-160641, is configured so that a shielding member which is holding in a first position rotates by a predetermined amount around its rotation shaft and moves to a second position. When the shielding member is in the first position, it shields an optical path of a laser luminous flux, and when it is in the second position, it opens (does not shield) the optical path of the laser luminous flux.

However, in a case that a configuration of the shielding member in the conventional example is applied to an optical scanning device of a color image forming apparatus, a rotating angle and a movable area of the shielding member which are required to open the optical path of the laser luminous flux increase, and there is a problem that the optical scanning device which accommodates the shielding member is upsized.

### SUMMARY OF THE INVENTION

In response to the above issue, an object of the present invention is to provide an optical scanning device which achieves miniaturization by miniaturizing a shielding member which shields a laser luminous flux and minimizing a movable area of the shielding member.

According to an aspect of the present invention, there is provided an optical scanning device comprising: a first light source configured to emit a first luminous flux; a second light source configured to emit a second luminous flux; a rotational polygon mirror configured to reflect and deflect the first luminous flux and the second luminous flux, the rotational polygon mirror reflecting the second luminous flux in a direction opposite to a direction of reflecting the first luminous flux as viewed in an axial direction of a rotation shaft of the rotational polygon mirror; a first lens through which the first luminous flux deflected by the rotational polygon mirror passes; a second lens through which the second luminous flux deflected by the rotational polygon mirror passes, the second lens being disposed on a side opposite to a side where the first lens is disposed as a boundary of the rotational polygon mirror with respect as viewed in the axial direction of the rotation shaft of the rotational polygon mirror; and a shielding member including a shielding wall configured to shield a first optical path from the first light source toward the rotational polygon mirror and a second optical path from the second light source toward the rotational polygon mirror, the shielding member being rotatable about a rotating shaft thereof and moving between a shielding position where the first optical path and the second optical path are shielded and a retracted position where the first optical path and the second optical path are opened by being rotated, wherein as viewed in the axial direction of the rotation shaft of the rotational polygon mirror, the rotating shaft of the shielding member is positioned between the first optical path and the second optical path and an axis of the rotating shaft of the shielding member extends in a direction crossing to an optical axis of the first lens.

Further features of the present invention will become apparent from the following description of exemplary embodiments with reference to the attached drawings.

### BRIEF DESCRIPTION OF THE DRAWINGS

FIG. 1 is a schematic sectional view showing an image forming apparatus according to an embodiment of the present invention.

FIG. 2 is a schematic perspective view showing an optical scanning device according to the embodiment.

FIG. 3 is a main portion of a schematic sectional view showing an inputting optical system to a rotational polygon mirror of the optical scanning device according to the embodiment.

FIG. 4 is a main portion of a schematic sectional view showing the inputting optical system to the rotational polygon mirror of the optical scanning device according to the embodiment.

FIG. 5 is a main portion of a schematic sectional view showing an optical scanning system of the optical scanning device according to the embodiment.

Part (a) and part (b) of FIG. 6 are schematic perspective views showing a shielding member according to the embodiment.

FIG. 7 is a schematic sectional view showing a mounting state of the optical scanning device and the shielding member according to the embodiment.

FIG. 8 is a schematic sectional view showing a mounting state of the optical scanning device and the shielding member according to the embodiment.

FIG. 9 is a main portion of a schematic perspective view showing a movement of the shielding member according to the embodiment.

FIG. 10 is an illustrative view showing a movement of the shielding member according to the embodiment.

FIG. 11 is a main portion of a schematic perspective view showing a movement of the shielding member according to the embodiment.

FIG. 12 is an illustrative view showing an effect according to the embodiment.

FIG. 13 is a drawing illustrating a problem in a conventional example.

### DESCRIPTION OF THE EMBODIMENTS

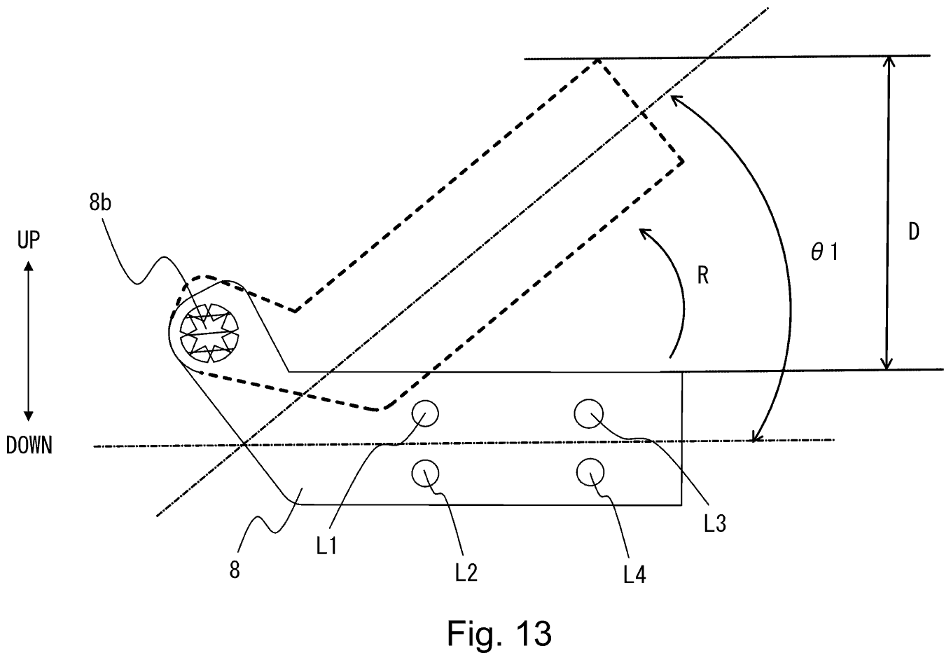

First of all, a case in which a conventional shielding member which is applied to an optical scanning device for a monochrome image forming apparatus is applied to a color image forming apparatus will be specifically described by using FIG. 13. For example, in an optical scanning device which is applied to a color image forming apparatus, it is necessary to shield and open optical paths of four laser luminous fluxes (Y, M, C and Bk) by a shielding member. In a case that a configuration of a conventional shielding member which is applied to a monochrome image forming apparatus is applied to this, a configuration becomes as shown in FIG. 13. A conventional shielding member 8 is arranged so that it intersects (for example, crosses perpendicularly) with the four laser luminous fluxes. Here, a laser luminous flux of Y is defined as L1, a laser luminous flux of M is defined as L2, a laser luminous flux of C is defined as L3 and a laser luminous flux of Bk is defined as L4. In an optical scanning device of a general color image forming apparatus, four of laser luminous fluxes are often arranged two by two in a vertical direction and are arranged with a certain space in a horizontal direction.

As shown in FIG. 13, in a configuration in which the configuration of the conventional shielding member 8 is applied to the optical scanning device of the color image forming apparatus, the shielding member 8, which is holding in a first position which is shown by a solid line, rotates a predetermined amount in a direction of an arrow R around a rotation shaft 8b and moves to a second position which is shown by a broken line. When the shielding member 8 is in the first position, it shields the optical paths of the laser luminous fluxes from L1 to L4, and when it is in the second position, it opens the optical paths of the laser luminous fluxes from L1 to L4.

A rotating angle of the shielding member 8 in such a configuration is determined by an angle θ1 in which the optical path of the laser luminous flux L1 which is the nearest from a center of the rotation shaft 8b is opened. Further, an outline of the shielding member 8 is determined by a position of the laser luminous flux L4 which is the farthest from the center of the rotation shaft 8b of the shielding member 8 (solid line). Therefore, in the conventional shielding member 8, a moving amount D in an up-and-down direction (vertical direction) becomes large by the movement from the first position (solid line) to the second position (dotted line). Thus, a movable area of the shielding member 8 is widen, and the optical scanning device which is accommodated becomes larger.

For this reason, in an embodiment which will be described below, when it is viewed in a direction of a rotational axis of a rotational polygon mirror, it has a configuration that the center of the rotation shaft of the shielding member is arranged in a center of a plurality of luminous fluxes which is incident on the rotational polygon mirror. Therefore, it is possible to minimize a shape of the shielding member which shields the luminous flux and an angle of rotation of the shielding member. In the following, embodiments of the present invention will be specifically described with reference to Figures.

### EMBODIMENT

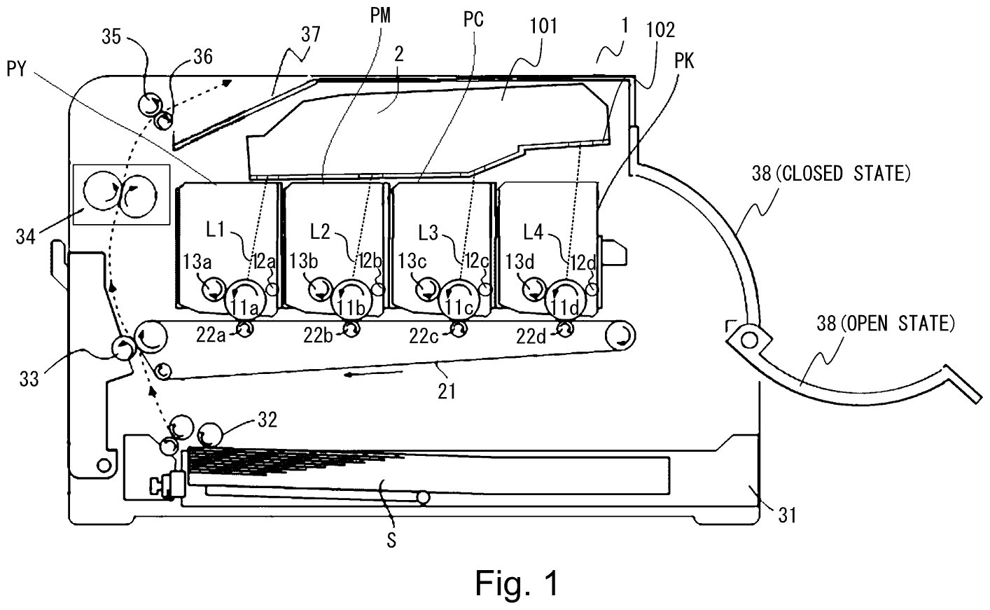

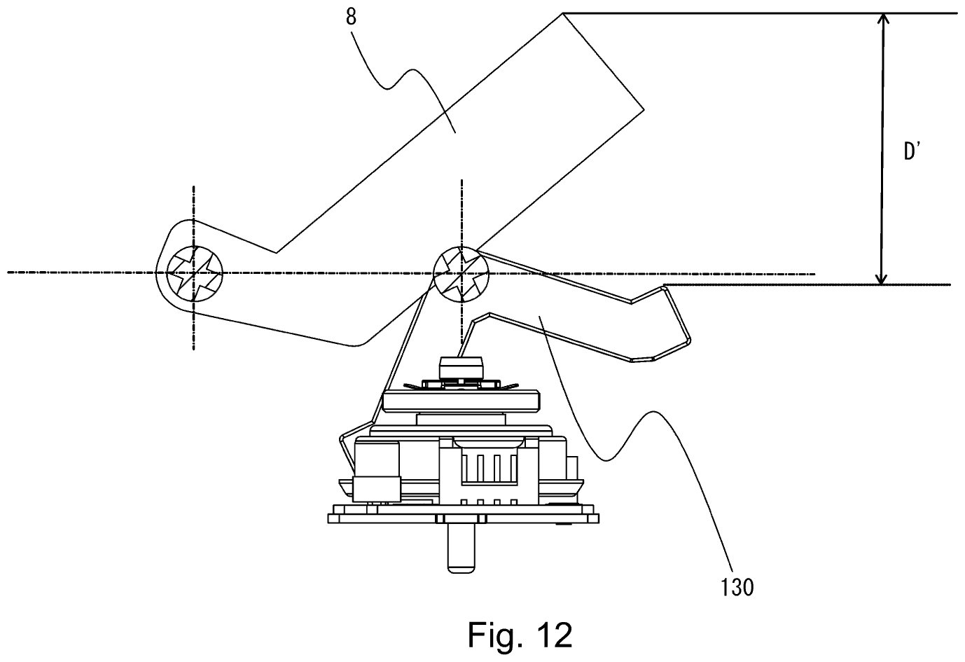

An image forming apparatus 1 according to the embodiment will be described by using FIG. 1 though FIG. 12.

### (Outline of Image Forming Apparatus)

FIG. 1 is a schematic sectional view of the image forming apparatus 1 according to the embodiment, and is a figure while an optical scanning device 2 and process cartridges PY, PM, PC and PK are mounted on the image forming apparatus 1. Incidentally, the image forming apparatus 1 according to the embodiment is a color image forming apparatus which superimposes four of color images of yellow, magenta, cyan and black and forms a full color image.

An image forming process will be described with reference to FIG. 1. The optical scanning device 2 is arranged on an upper side of photosensitive drums 11a, 11b, 11c and 11d, with respect to a vertical direction, which are image bearing members (also scanned members) which are provided in the process cartridges PY, PM, PC and PK. The optical scanning system 2 images and scans the laser luminous fluxes L1, L2, L3 and L4 on the photosensitive drums 11a, 11b, 11c and 11d, respectively. The optical scanning device 2 is fixed to a frame of the image forming apparatus 1 by springs or screws (not shown). Further, an optical box 101, which is a casing which accommodates optical components, etc. which will be described below, is arranged on an upper side of the image forming apparatus 1 with respect to the vertical direction. The optical box 101 is blocked at an opening by a lid 102. The lid 102 is mounted on the optical box 101 with screws, etc. and is arranged on a lower side of the optical box 101 with respect to the vertical direction.

The photosensitive drums 11a, 11b, 11c and 11d are charged in advance by charging rollers 12a, 12b, 12c and 12d of charging devices, and electrostatic latent images are formed on surfaces of the photosensitive drums when charges are absent only on portions in which the laser luminous fluxes L1, L2, L3 and L4 are irradiated. The electrostatic latent images become toner images by developing rollers 13a, 13b, 13c and 13d which are developing means of developing devices, and the toner images are superimposed and transferred onto an intermediary transfer belt 21 by primary transfer rollers 22a, 22b, 22c and 22d. On the other hand, a recording paper S, which is stored in a cassette 31 which is arranged on a lower side of the intermediary transfer belt 21, is taken out by a pickup roller 32 while matching the timing with an image forming process and, after that, the four color toner image on the intermediary transfer belt 21 is transferred by a secondary transfer roller 33. The recording paper S finally passes through a fixing device 34, the unfixed toner image is fixed, and the recording paper S is discharged to a discharge tray 37 outside the image forming apparatus 1 by fixing rollers 35 and 36. Further, a front door 38 (door), which is able to open and close, for example, when a user replaces the process cartridges PY, PM, PC and PK, etc., is provided with the image forming apparatus 1. Incidentally, the front door 38 becomes in a closed state or an open state.

### (Outline of Optical Scanning Device)

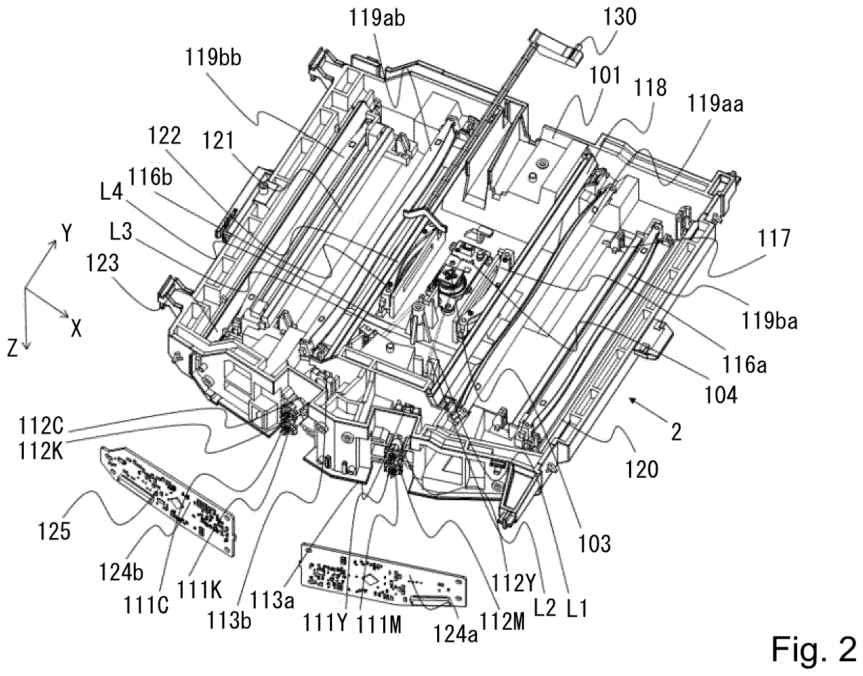

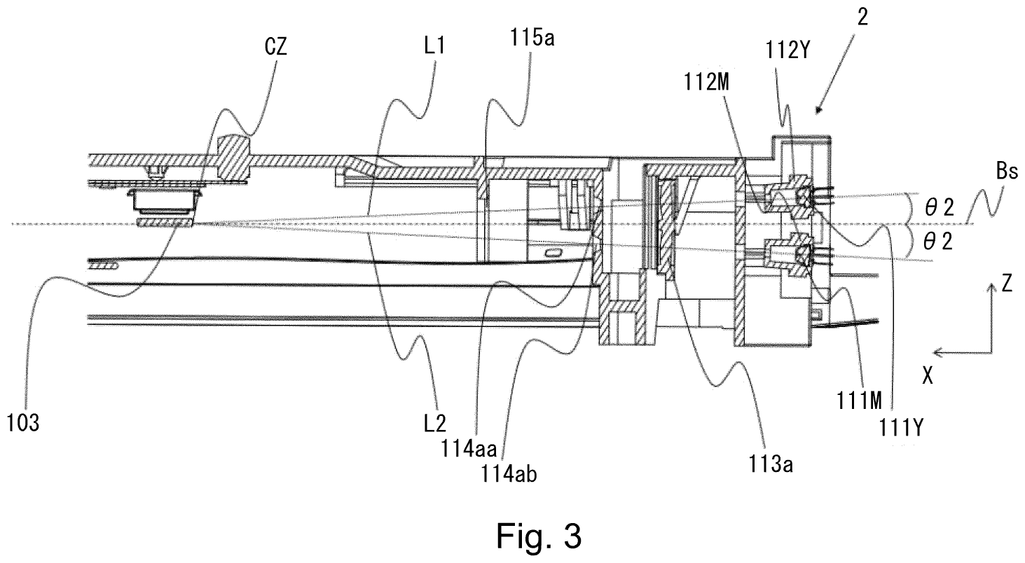

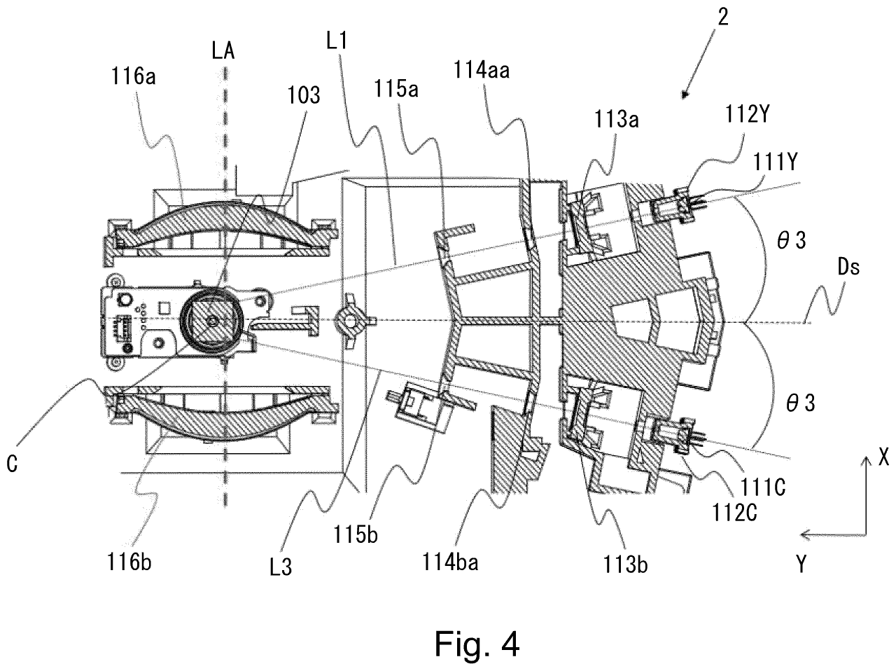

Next, the optical scanning device 2 according to the embodiment will be described by using from FIG. 2 through FIG. 5. FIG. 2 is a schematic perspective view showing a configuration of the optical scanning device 2. Further, a coordinate system in the embodiment is as shown in FIG. 2. Here, a Z direction is defined as a sub scanning direction and a Y direction is defined as a main scanning direction. Further, a virtual plane which is perpendicular (orthogonal) to a Z axis is defined as a scanning plane (a second virtual plane). FIG. 3 is a sectional view of an inputting optical system which shows the optical paths of the laser luminous fluxes L1 and L2 until they reach the rotational polygon mirror 103, and FIG. 4 is a sectional view of an incident optical system which shows the optical paths of the laser luminous fluxes L1 and L3 until they reach the rotational polygon mirror 103. FIG. is a sectional view of an optical scanning system which shows the optical paths of the respective laser luminous fluxes L1, L2, L3 and L4 which are deflected and scanned by the rotational polygon mirror 103 until they reach the photosensitive drums 11a, 11b, 11c and 11d. Further, in a following description, the optical scanning systems which are corresponding to the respective colors are referred to as a Y station, a M station, a C station and a K station.

As shown in FIG. 2, a scanner motor 104 which rotationally drives the rotational polygon mirror 103 is mounted on the optical box 101 which is molded from resin, etc. by screws (not shown). Next, configurations of the laser luminous fluxes L1, L2, L3 and L4, which emit from semiconductor lasers 111 (111Y, 111M, 111C and 111K) which are a plurality of light sources until they are incident on the rotational polygon mirror 103, will be described by using FIG. 2, FIG. 3 and FIG. 4. Incidentally, in the embodiment, the laser luminous fluxes corresponding to the Y station, the M station, the C station and the K station are defined as L1, L2, L3 and L4, respectively. In FIG. 1, etc., the laser luminous flux L1 is defined as a first luminous flux and an optical path of the laser luminous flux L1 is defined as a first optical path, while the laser luminous flux L3 is defined as a second luminous flux and an optical path of the laser luminous flux L3 is defined as a second optical path. A semiconductor laser 111Y which emits the laser luminous flux L1 is defined as a first light source, and a semiconductor laser 111C which emits the laser luminous flux L3 is defined as a second light source. Incidentally, the laser luminous flux L2 may also be regarded as the first optical flux and the optical path of the laser luminous flux L2 may also be regarded as the first optical path. Further, the laser luminous flux L4 may also be regarded as the second optical flux and the optical path of the laser luminous flux L4 may also be regarded as the second optical path. Further, a semiconductor laser 111M which emits the laser luminous flux L2 may also be regarded as the first light source, and a semiconductor laser 111K which emits the laser luminous flux L4 may also be regarded as the second light source.

The first light source and the second light source are arranged, so that when they are viewed in a direction of a rotation shaft of the rotational polygon mirror 103 (a direction of a first rotational axis), the first optical path and the second optical path are symmetrical with respect to a virtual plane (first virtual plane) (Ds in FIG. 4 which will be described below) which passes through the first rotational axis and is parallel to a direction of the first rotational axis. The rotational polygon mirror 103 reflects the second luminous flux in a direction which is opposite to a direction in which the first luminous flux is reflected, when it is viewed in an axial direction of the rotation shaft of the rotational polygon mirror 103.

The optical scanning device according to the embodiment is an oblique incident scanning optical system. The oblique incident scanning optical system is an optical system in which the laser luminous fluxes L1 and L2 are obliquely incident on a deflecting and reflecting surface of the rotational polygon mirror 103, as shown in FIG. 3. The specific configuration is that laser holders 112 (112Y, 112M, 112C and 112K) which hold semiconductor lasers 111 (111Y, 111M, 111C and 111K) are arranged up and down in a Z direction and are also arranged to be tilted with respect to an X axis. The laser luminous fluxes L1 and L2 which emit from the semiconductor lasers 111Y and 111M are incident on the deflecting and reflecting surface of the rotational polygon mirror 103 at a predetermined angle θ2 with respect to a virtual surface Bs which is parallel to the scanning plane and passes through a center CZ in the Z direction on the deflecting and reflecting surface of the rotational polygon mirror 103.

Further, in the embodiment, the laser holders 112 (112Y, 112M, 112C and 112K) are arranged right and left in the X direction (horizontal direction) and are also arranged to be tilted with respect to a Y axis as shown in FIG. 4. The laser luminous fluxes L1 and L3 which emit from the semiconductor lasers 111Y and 111C are incident on the deflecting and reflecting surface of the rotational polygon mirror 103 at a predetermined angle θ3 with respect to a virtual plane Ds which is perpendicular to the scanning plane and passes through a center Cr (the first rotational axis) of the rotational polygon mirror 103. Incidentally, the laser holders 112 (112Y, 112M, 112C and 112K) are fixed to the optical box 101 by, for example, UV adhesive, etc. after their positions are adjusted in the X, Y, and Z directions by a tool (not shown).

Next, as shown in FIG. 3, the laser luminous fluxes L1 and L2 which are emitted from the semiconductor lasers 111 (111Y, 111M) are converted to substantially parallel light or convergent light in the main scanning direction and convergent light in the sub scanning direction by an anamorphic lens 113a in which a collimator lens and a cylindrical lens are integrally molded. After that, the laser luminous fluxes L1 and L2 are restricted in widths of the luminous fluxes by sub scanning aperture diaphragms 114a (114aa and 114ab) and a main scanning aperture diaphragm 115a and form a focal line image with a constant width in the main scanning direction on the deflecting and reflecting surface of the rotational polygon mirror 103. By making the laser luminous fluxes obliquely incident on the deflecting and reflecting surface of the rotational polygon mirror 103, the laser luminous fluxes L1 and L2 are separated into up and down optical paths after being reflected by the rotational polygon mirror 103. Incidentally, the laser luminous fluxes L3 and L4 which correspond to the laser luminous fluxes L1 and L2 are configured in the same way as described above, and are converted to substantially parallel light or convergent light in the main scanning direction and convergent light in the sub scanning direction by the anamorphic lens 113b (see FIG. 4). After that, the laser luminous fluxes L3 and L4 are restricted in widths of the luminous fluxes by sub scanning aperture diaphragms 114b (114ba and 114bb) (see FIG. 4. Incidentally, 114bb is not shown.) and a main scanning aperture diaphragm 115b. The anamorphic lenses 113 (113a and 113b), the sub scanning aperture apertures 114 (114aa, 114ab, 114ba and 114bb), and the main scanning aperture diaphragms 115 (115a and 115b) are included in a first optical member.

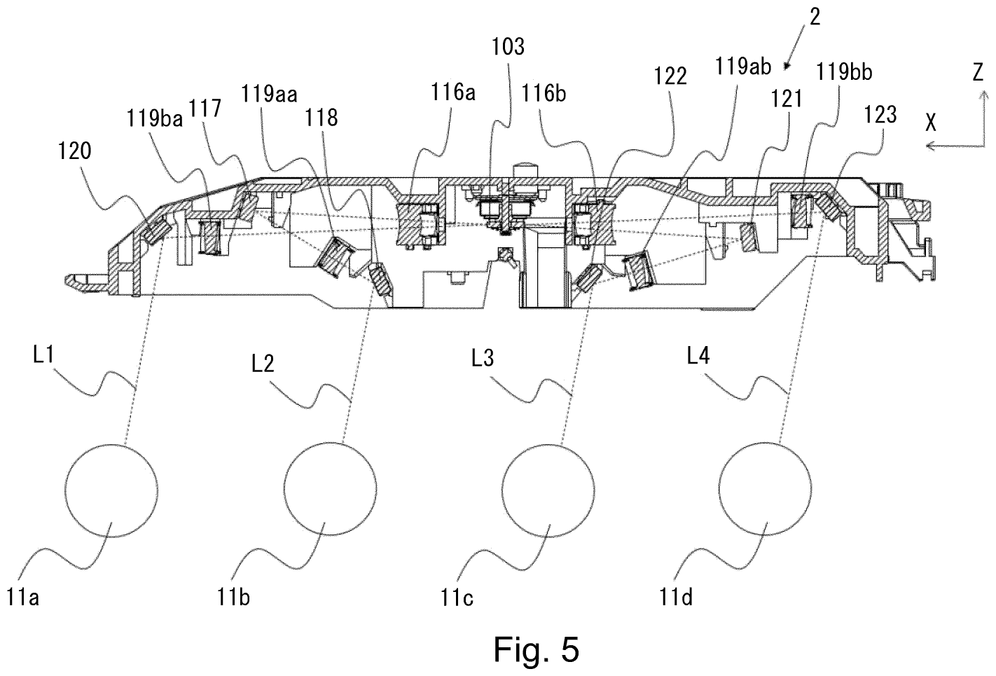

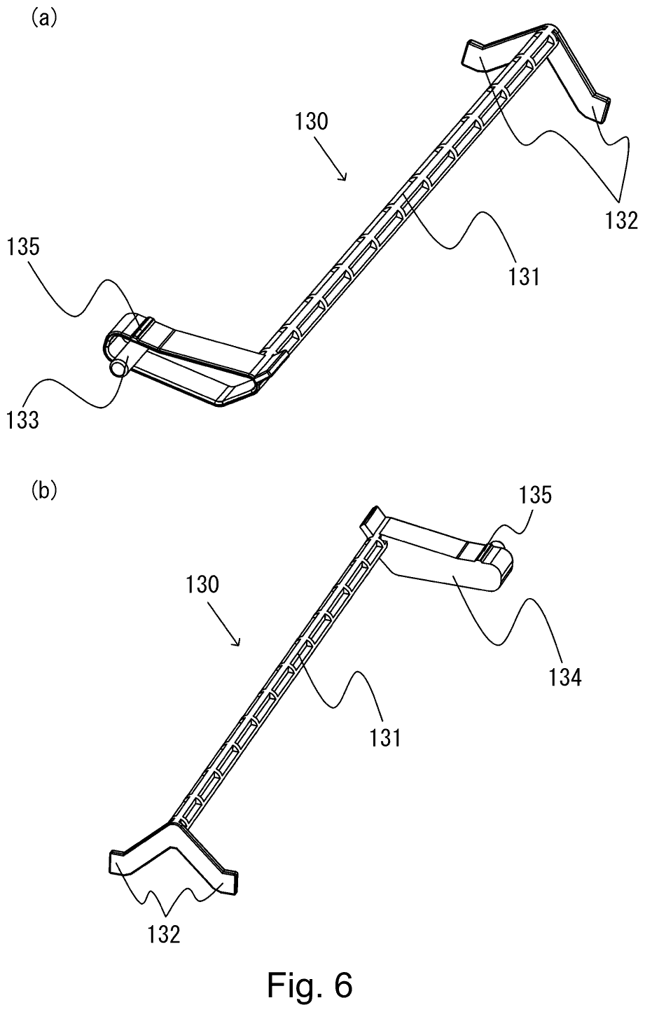

Next, the optical scanning system according to the embodiment will be described by using FIG. 2 and FIG. 5. First, the optical paths of the laser luminous fluxes L1 and L2 will be described. The laser luminous fluxes L1 and L2 which are reflected by the rotational polygon mirror 103 are incident on a first imaging lens 116a (a first lens) which is a common first imaging means. Of the laser luminous fluxes L1 and L2 which pass through the first imaging lens 116a, the laser luminous flux L2 which is on an upper side in the Z direction is reflected by a first reflecting mirror 117. After that, after passing through a second imaging lens 119aa, the laser luminous flux L2 is reflected by a second reflecting mirror 118 and reaches a photosensitive drum 11b.

Of the laser luminous fluxes L1 and L2 which pass through the first imaging lens 116a, the laser luminous flux L1 which is on a lower side in the Z direction passes under the first reflecting mirror 117. After that, the laser luminous flux L1 passes through a second imaging lens 119ba, is reflected by a third reflecting mirror 120, and reaches a photosensitive drum 11a. The first imaging lens 116a is commonly used by the laser luminous fluxes L1 and L2, while the second imaging lenses 119aa and 119ba are separately provided for the laser luminous fluxes L1 and L2.

Next, the optical paths of the laser luminous fluxes L3 and L4 will be described. The laser luminous fluxes L3 and L4 which are reflected by the rotational polygon mirror 103 are incident on a first imaging lens 116b (a second lens) which is the common first imaging means. Of the laser luminous fluxes L3 and L4 which pass through the first imaging lens 116b, the laser luminous flux L3 which is on a lower side in the Z direction is reflected by a fourth reflecting mirror 121. After that, after passing through a second imaging lens 119ab, the laser luminous flux L3 is reflected by a fifth reflecting mirror 122 and reaches a photosensitive drum 11c. The first imaging lens 116b (the second lens) is arranged on an opposite side of a side on which the first imaging lens 116a (the first lens) is arranged with respect to the rotational polygon mirror 103 as a border, when it is viewed in the axial direction of the rotation shaft of the rotational polygon mirror 103. Of the laser luminous fluxes L1 and L2 which pass through the first imaging lens 116b, the laser luminous flux L4 which is on an upper side in the Z direction passes above the fourth reflecting mirror 121. After that, the laser luminous flux L4 passes through a second imaging lens 119bb, is reflected by a sixth reflecting mirror 123, and reaches a photosensitive drum 11d.

The first imaging lens 116b is commonly used by the laser luminous fluxes L3 and L4, while the second imaging lenses 119ab and 119bb are separately provided for the laser luminous fluxes L3 and L4. Further, each imaging lens is fixed to the optical box 101 by UV adhesive and each reflecting mirror is fixed to the optical box 101 by an urging member (not shown). The plurality of imaging lenses and plurality of reflecting mirrors which are described above are included in a second optical member.

Further, as shown in FIG. 2, a beam detector (in the following, it will be referred to as BD) 125 is mounted on a control board 124b to which terminals of the semiconductor lasers 111C and 111K are attached. In the embodiment, the laser luminous flux L4 is reflected by the rotational polygon mirror 103, deflected and scanned, and incident on the BD 125. At this time, the image of each color is written out based on the signal output from BD 125 (BD signal). Incidentally, the terminals of the semiconductor lasers 111Y and 111M are attached to a control board 124a.

### (Constitution of Shielding Member)

Next, a configuration of a shielding member 130 according to the embodiment will be described by using part (a) of FIG. 6 and part (b) of FIG. 6. First, a role of the shielding member 130 will be described. The shielding member 130 according to the embodiment is provided so that a shielding wall 132, which will be described below, is positioned between the rotational polygon mirror 103 and the first optical member. The shielding member 130 includes a rotation shaft (a rotating shaft) 131, which is a second rotation shaft, and the shielding wall 132 which is possible to move between a shielding state (a shielding position) and a retracted state (a retracted position) by rotating around the rotation shaft 131. Here, the shielding state is a state in which the shielding wall 132 shields the first optical path and the second optical path which are incident on the reflecting surface of the rotational polygon mirror 103. Further, the retracted state is a state in which the shielding wall 132 does not shield the first optical path and the second optical path which are incident on the reflecting surface of the rotational polygon mirror 103. The rotating shaft 131 of the shielding member 130 is positioned between the first optical path and the second optical path when it is viewed in the axial direction of the rotation shaft of the rotational polygon mirror 103, and an axis of the rotating shaft 131 of the rotational polygon mirror 103 extends in a direction crossing an optical axis LA (see FIG. 4) of the first imaging lens 116a (the first lens). The shielding member 130 according to the embodiment is arranged so that the rotation shaft 131 is positioned on a bisecting line of an angle which is formed by the first optical path and the second optical path, when it is viewed in the direction of the rotation shaft (Z direction) of the rotational polygon mirror 103.

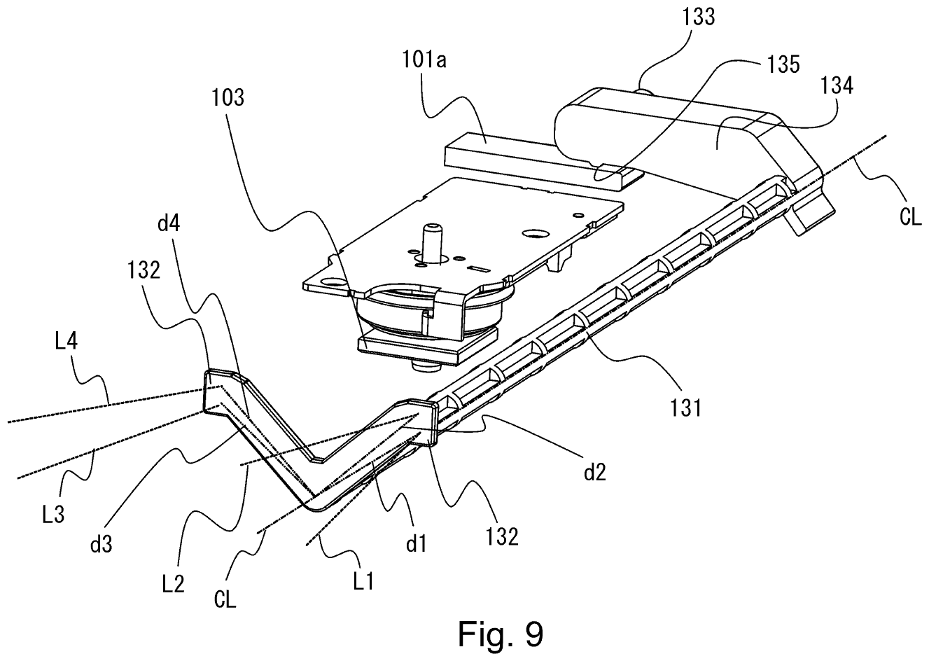

The shielding member 130 includes the V-shaped shielding wall 132 at one end of the rotation shaft 131 and a restricting wall 134 at the other end of the rotation shaft 131. Incidentally, the rotation shaft 131 is provided in a V-shaped curved portion so that it is perpendicular to the shielding wall 132 and is perpendicular to the restricting wall 134. On the other hand, the optical box 101 includes a contacting portion (a contacting portion 101a in FIG. 9 which will be described below) which abuts against the restricting wall 134 when the shielding member 130 is in the shielding state.

In a case that the laser luminous fluxes L1, L2, L3 and L4, which emit from the semiconductor laser 111, hit a human body directly, they may cause damage to eyes, for example. Accordingly, when a user opens the front door 38, for example, in order to replace the process cartridges PY, PM, PC and PK, it is necessary to take measures to prevent the laser luminous fluxes L1, L2, L3 and L4 from leaking out of the optical scanning device 2. Therefore, in the embodiment, when the front door 38 is closed, that is, during image forming, the optical paths of the laser luminous fluxes L1, L2, L3 and L4 from the semiconductor laser 111 to the rotational polygon mirror 103 are opened (not shielded). On the other hand, when the front door 38 is opened, a configuration, in which the optical paths of the laser luminous fluxes L1, L2, L3 and L4 from the semiconductor laser 111 to the rotational polygon mirror 103 are shielded by the shielding member 130, is applied.

Part (a) and part (b) of FIG. 6 are a schematic perspective view of the shielding member 130 according to the embodiment. As shown in part (a) and part (b) of FIG. 6, the shielding member 130 is configured of the rotation shaft 131, the shielding wall 132, a boss portion 133, the restricting wall 134 and a positioning protrusion 135. The shielding wall 132 is provided with one end portion of the rotation shaft 131, while the boss portion 133, the restricting wall 134 and the positioning protrusion 135 are provided with the other end portion of the rotation shaft 131.

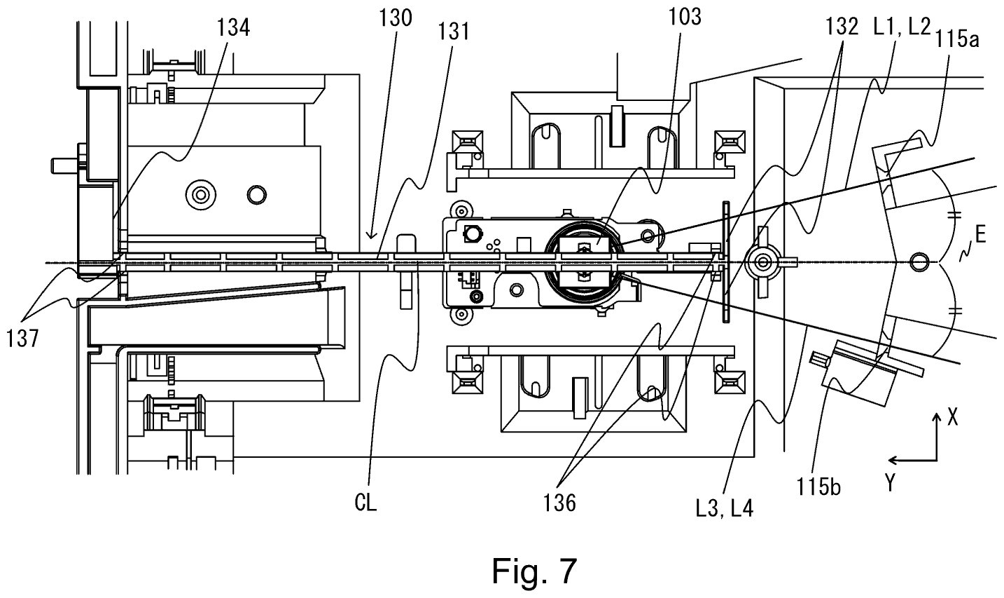

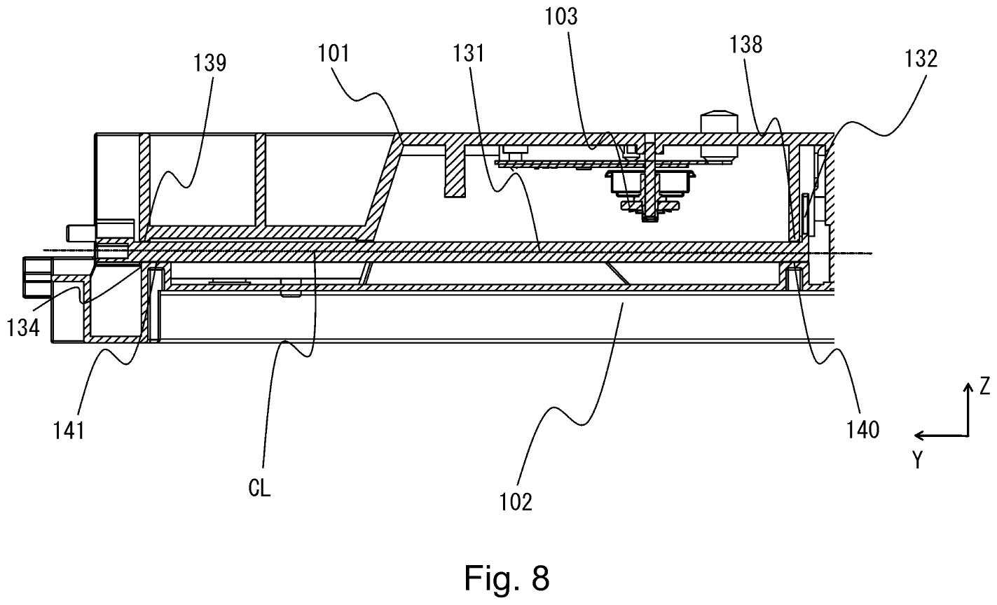

A top view of the shielding member 130 according to the embodiment while the shielding member 130 is mounted on the optical box 101 is shown in FIG. 7, and a sectional view of it is shown in FIG. 8. First, a center CL of the rotation shaft 131 of the shielding member 130 is arranged in a lower portion of (below) the rotational polygon mirror 103 with respect to the Z direction, as shown in FIG. 8. Further, as shown in FIG. 7, the center CL of the rotation shaft 131 of the shielding member 130 is arranged on a bisecting line E of the laser luminous fluxes L1 and L2 and the laser luminous fluxes L3 and L4 which are incident from the semiconductor laser 111 on the rotational polygon mirror 103 with respect to the X direction.

### (Positional Restriction of Shielding Member)

Next, a positional restriction of the shielding member 130 with respect to the optical scanning device 2 will be described. As shown in FIG. 7, in the X direction, the rotation shaft 131 is restricted by a first restricting wall 136 and a second restricting wall 137 which are provided with the optical box 101. For more detail, the first restricting wall 136 includes two walls which are aligned in the X direction, and restricts movement in the X direction by sandwiching the rotation shaft 131 between the two walls on a side of the shielding wall 132 (a side of the shielding wall) in the axial direction of the rotation shaft 131. The second restricting wall 137 includes two walls which are aligned in the X direction, and restricts movement in the X direction by sandwiching the rotation shaft 131 between the two walls on a side of the restricting wall 134 (a side of the restricting wall). In the Y direction, the shielding wall 132 and the restricting wall 134 sandwich the first restricting wall 136 and the second restricting wall 137 which are described above to restrict movement in the Y direction.

A third restricting wall 138 and a fourth restricting wall 139 are provided with the optical box 101. A fifth restricting wall 140 which is arranged at a position which opposes the third restricting wall 138 and a sixth restricting wall 141 which is arranged at a position which opposes the fourth restricting wall 139 are provided with the lid 102. As shown in FIG. 8, in the Z direction, the side of the shielding wall 132 of the rotation shaft 131 is restricted by the third restricting wall 138 and the fifth restricting wall 140, and the side of the restricting wall 134 of the rotation shaft 131 is restricted by the fourth restricting wall 139 and the sixth restricting wall 141. Further, in order to allow the shielding member 130 to operate smoothly, a clearance is provided in each restricting portion with respect to the X, Y, and Z directions. Further, the shielding wall 132 is arranged between the rotational polygon mirror 103 and the main scanning aperture diaphragms 115a and 115b. That is, the shielding wall 132 of the shielding member 130, to which the first luminous flux and the second luminous flux are exposed, is arranged between an optical member which is the closest to the rotational polygon mirror 103 among the first optical member and the rotational polygon mirror 103.

In the above, the optical box 101 includes the first restricting wall 136 and the second restricting wall 137 which restrict the rotation shaft 131 in the X direction. The shielding member 130 restricts movement in the main scanning direction by sandwiching the first restricting wall 136 and the second restricting wall 137 by the shielding wall 132 and the restricting wall 134. The optical box 101 includes the third restricting wall 138 and the fourth restricting wall 139. The lid 102 includes the fifth restricting wall 140 which restricts movement of the shielding wall 132 in the Z direction together with the third restricting wall 138, and the sixth restricting wall 141 which restricts movement of the restricting wall 134 in the Z direction together with the fourth restricting wall 139.

### (Operation of Shielding Member)

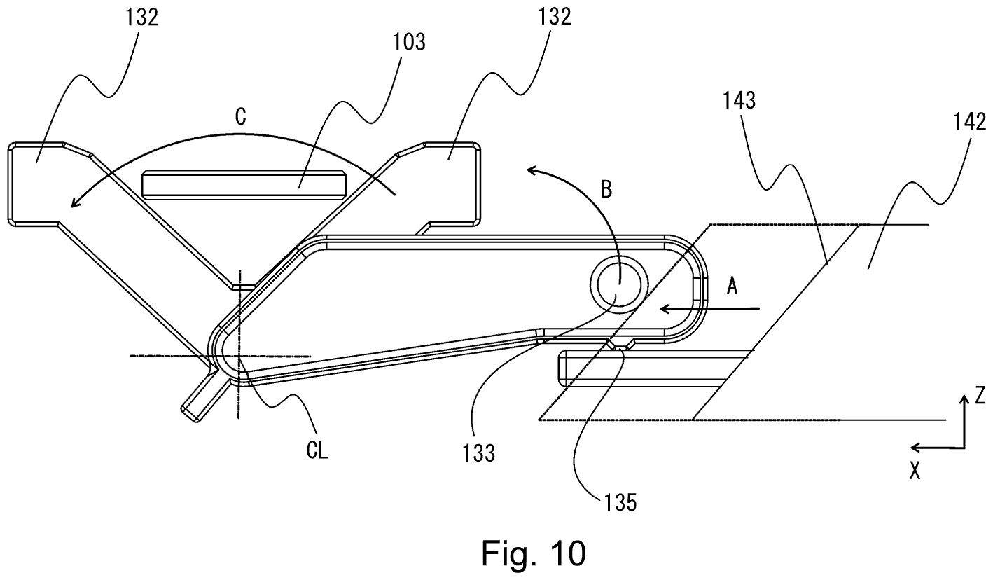

Next, an operation of the shielding member 130 according to the embodiment will be described by using from FIG. 9 through FIG. 11. The front door 38 becomes in the open state in order to access to an inside of the image forming apparatus 1, and becomes in the closed state when image forming is performed. The shielding member 130 is in the shielding state when the front door 38 is in the open state, and is in the retracted state when the front door 38 is in the closed state. The restricting wall 134 includes the boss portion 133. The image forming apparatus 1 includes a moving member 142 (see FIG. 10) which moves in interrelation with the front door 38, and when the moving member 142 moves the boss portion 133, the shielding member 130 is rotated around the rotation shaft 131.

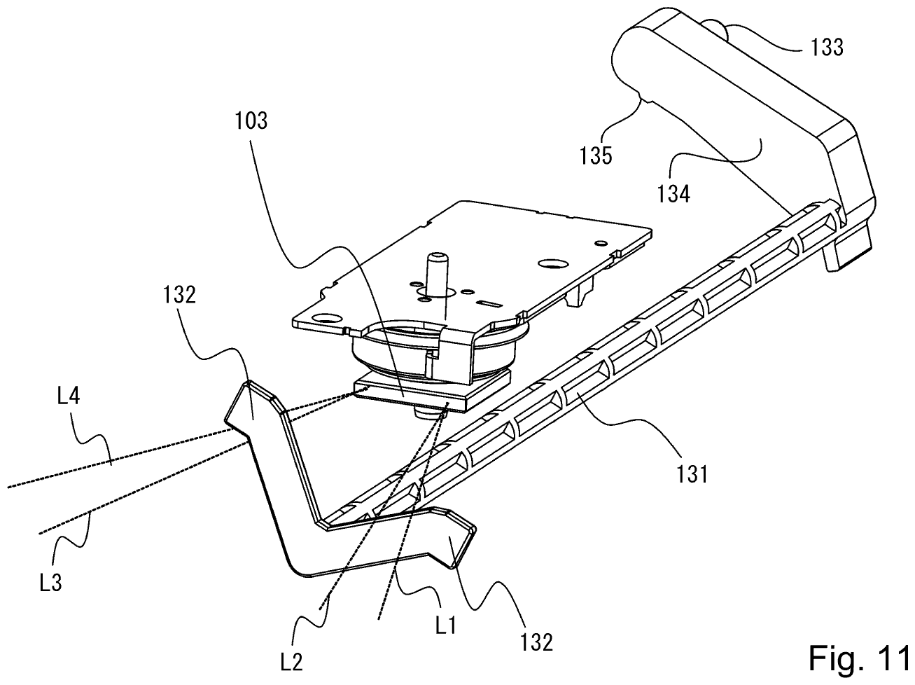

FIG. 9 is a view showing a positional relationship between the shielding member 130 while the front door 38 is open, the laser luminous fluxes L1, L2, L3 and L4, and the rotational polygon mirror 103. FIG. 10 is a view showing an operation of the shielding member 130 when the front door 38 changes from a state which is shown in FIG. 9 to the closed state. FIG. 11 is a view showing a positional relationship between the shielding member 130 while the front door 38 is closed, that is, during a time of image forming, the laser luminous fluxes L1, L2, L3 and L4, and the rotational polygon mirror 103.

First, as shown in FIG. 9, when the front door 38 is open, the shielding wall 132 shields the optical paths of the laser illuminous fluxes L1, L2, L3 and L4 from the semiconductor laser 111 to the rotational polygon mirror 103 so that the laser illuminous fluxes L1, L2, L3 and L4 do not leak out of the optical scanning device 2. At this time, the shielding member 130 maintains its attitude when the positioning protrusion 135 contacts a contacting portion 101a which is a part of the optical box 101. When the front door 38 is closed from a state which is shown in FIG. 9, as shown in FIG. 10, the moving member 142 which is provided with the image forming apparatus 1 moves in a direction of an arrow A in interrelation with an operation of the front door 38, and a contacting surface 143 which is provided with the moving member 142 contacts the boss portion 133.

Further, the contacting surface 143 is an inclined slope with respect to the Z direction. The reason why the contacting surface 143 is the inclined slope is to rotate the boss portion 133 in a direction of an arrow B around the center CL of the rotation shaft 131 as a center of rotation by applying a force in the Z direction to the boss portion 133. Further, when the boss portion 133 rotates in the direction of the arrow B, the shielding wall 132 rotates in a direction of an arrow C. By the time the front door 38 is closed, the boss portion 133 rotates a predetermined amount and becomes in a state which is shown in FIG. 11.

In FIG. 11, the optical paths of the laser illuminous fluxes L1, L2, L3 and L4 from the semiconductor laser 111 to the rotational polygon mirror 103 is opened, and it is possible to perform image forming. Further, in the embodiment, as shown in FIG. 11, it is a configuration that the laser illuminous fluxes L1 and L2 pass through an upper side of the shielding wall 132 with respect to a vertical direction, and the laser illuminous fluxes L3 and L4 pass through a lower side of the shielding wall 132 with respect to the vertical direction. The shielding wall 132 is formed in a V-shape, and it is possible to realize the way which is described above since the rotation shaft 131 is positioned in the curved portion of the V-shape.

### (Distances d1, d2, d3 and d4)

As described so far, in the optical scanning device 2 of the color image forming apparatus 1, it is necessary to shield and open the optical paths of the four laser illuminous fluxes L1, L2, L3 and L4 by the shielding member 130. In the embodiment, as shown in FIG. 7, the center CL of the rotation shaft 131 of the shielding member 130 is arranged on the bisecting line E of the laser luminous fluxes L1 and L2 and the laser luminous fluxes L3 and L4 which are incident from the semiconductor laser 111 on the rotational polygon mirror 103 with respect to the X direction. Therefore, as shown in FIG. 9, it is possible to substantially equalize each of distances d1, d2, d3 and d4 from the center CL of the rotation shaft 131 to the laser illuminous flux L1, L2, L3 and L4, respectively.

For more detail, the distances d1, d2, d3 and d4 are distances respectively, which will be described below, when the shielding member 130 is in the shielding state. The distance d1 is a distance from a position in which the laser illuminous flux L1 intersects the shielding wall 132 to the rotation shaft 131. The distance d2 is a distance from a position in which the laser illuminous flux L2 intersects the shielding wall 132 to the rotation shaft 131. The distance d3 is a distance from a position in which the laser illuminous flux L3 intersects the shielding wall 132 to the rotation shaft 131. The distance d4 is a distance from a position in which the laser illuminous flux L4 intersects the shielding wall 132 to the rotation shaft 131. In the embodiment, the distances d1, d2, d3 and d4 are the same. Therefore, it is possible to shield and open the optical paths at approximately the same rotating angle for the laser illuminous fluxes L1 and L4 and the laser illuminous fluxes L2 and L3 which are opposing. Thus, the rotating angle of the shielding member 130 is reduced.

Incidentally, in the embodiment, the rotating angle of the shielding member 130 may be set to 25°, for example, in order to securely shield and open the optical paths of the four laser illuminous fluxes L1, L2, L3 and L4, after considering tolerance of each parts and mounting error. Incidentally, in an example which is shown in FIG. 13, it is necessary to set a rotating angle θ1 to 40°.

FIG. 12 is a view comparing a configuration of the embodiment after the shielding member 130 is rotated with the conventional shielding member 8 which is shown in FIG. 13. As shown in FIG. 12, comparing these two configurations, it is possible to realize what will be described below, while the shielding member 130 is rotated. That is, while the optical paths of the laser illuminous fluxes L1, L2, L3 and L4 from the semiconductor laser 111 to the rotational polygon mirror 103 are opened, it is possible to reduce a movable area of the shielding member 130 in height by approximately 21 mm (D′) in height in the Z direction. Incidentally, it is possible to achieve the similar effect, even when the center CL of the rotation shaft 131 of the shielding member 130 is shifted in some degree From the bisecting line E of the laser luminous fluxes L1 and L2 and the laser luminous fluxes L3 and L4 which are incident from the semiconductor laser 111 on the rotational polygon mirror 103 with respect to the X direction.

As described above, the center CL of the rotation shaft 131 of the shielding member 130 in the optical scanning device 2 of the color image forming apparatus 1 is arranged on the bisecting line E of the laser luminous fluxes L1 and L2 and the laser luminous fluxes L3 and L4 which are incident from the semiconductor laser 111 on the rotational polygon mirror 103 with respect to the X direction. In this way, it is possible to reduce the rotating angle of the shielding member. Therefore, since it is possible to reduce the movable area of the shielding member 130 in a height direction, it is possible to realize a miniaturization of the optical scanning device 2 and the image forming apparatus 1.

Incidentally, since distances d1, d2, d3 and d4 from the center CL of the rotation shaft 131 of the shielding member 130 to the laser illuminous flux L1, L2, L3 and L4 respectively are substantially equal in the embodiment, it is possible to minimize the shape of the shielding wall 132. Therefore, since volume of a component part of the optical scanning device 2, for example, such as the optical box 101 which accommodates the shielding member 130, etc. as well as the shielding member 130, is reduced, it results in a cost reduction in terms of material costs.

Further, since it is possible to minimize the shape of the shielding wall 132, it is possible to suppress a thermal deformation of the shielding wall 132. Specifically, for example, it is the thermal deformation of the shielding wall 132 which occurs, for example, after storage in a high temperature environment such as 60° C. or due to a heat which is generated by a drive IC which is associated with high speed rotation of the scanner motor 104. That is, it is possible to reduce contribution of the thermal deformation of the shielding member 130, which is one of concerns that should be considered when setting a necessary rotating angle of the shielding member 130 for shielding and opening the optical paths of the laser illuminous fluxes L1, L2, L3 and L4. Therefore, it is possible to increase a degree of a design freedom of a configuration of the shielding member 130, for example, by moderating single part tolerance of the shielding member 130.

As described above, according to the embodiment, by achieving miniaturization of a shielding member which shields a laser luminous flux and minimizing a movable area of the shielding member, it is possible to realize miniaturization of an optical scanning device without reducing mechanical precision due to thermal deformation, etc.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-041628 filed on Mar. 16, 2023, which is hereby incorporated by reference herein in its entirety.

What is claimed is:

1. An optical scanning device comprising:
a first light source configured to emit a first luminous flux;
a second light source configured to emit a second luminous flux;
a rotational polygon mirror configured to reflect and deflect the first luminous flux and the second luminous flux, the rotational polygon mirror reflecting the second luminous flux in a direction opposite to a direction of reflecting the first luminous flux as viewed in an axial direction of a rotation shaft of the rotational polygon mirror;
a first lens through which the first luminous flux deflected by the rotational polygon mirror passes;
a second lens through which the second luminous flux deflected by the rotational polygon mirror passes, the second lens being disposed on a side opposite to a side where the first lens is disposed as a boundary of the rotational polygon mirror with respect as viewed in the axial direction of the rotation shaft of the rotational polygon mirror; and
a shielding member including a shielding wall configured to shield a first optical path from the first light source toward the rotational polygon mirror and a second optical path from the second light source toward the rotational polygon mirror, the shielding member being rotatable about a rotating shaft thereof and moving between a shielding position where the first optical path and the second optical path are shielded and a retracted position where the first optical path and the second optical path are opened by being rotated,
wherein as viewed in the axial direction of the rotation shaft of the rotational polygon mirror, the rotating shaft of the shielding member is positioned between the first optical path and the second optical path and an axis of the rotating shaft of the shielding member extends in a direction crossing to an optical axis of the first lens.

2. An optical scanning device according to claim 1, wherein as viewed in the axial direction of the rotation shaft of the rotational polygon mirror, the shielding member is disposed such that the rotating shaft of the shielding member aligns along a bisector of an angle formed by the first optical path and the second optical path.

3. An optical scanning device according to claim 1, further comprising first optical members including a lens for converting a luminous flux to a convergent light and an aperture diaphragm for restricting a width of the luminous flux are disposed within the first optical path and the second optical path, respectively,
wherein the shielding wall of the shielding member which the first luminous flux and the second luminous flux strike is disposed between a optical member closest to rotational polygon mirror of the first optical members and the rotational polygon mirror.

4. An optical scanning device according to claim 1, wherein the rotating shaft of the shielding member is disposed below the rotational polygon mirror with respect to a vertical direction.

5. An optical scanning device according to claim 1, further comprising a casing configured to accommodate the rotational polygon mirror, the first lens and the second lens,
wherein the shielding member includes the shielding wall at one end of the rotating shaft of the shielding member and a restricting wall at the other end of the rotating shaft of the shielding member, and
wherein the casing includes a contacting portion configured to contact the restricting wall when the shielding member is in the shielding position.

6. An optical scanning device according to claim 1, wherein as viewed in the axial direction of the rotating shaft of the shielding member, the shielding wall is a V-shape, and
wherein the rotating shaft is provided in a bending portion of the V-shape so as to be perpendicular to the shielding wall.

7. An optical scanning device according to claim 1, wherein a distance from a position where the first luminous flux crosses with the shielding wall to the rotating shaft of the shielding member and a distance from a position where the second luminous flux crosses with the shielding wall to the rotating shaft of the shielding member are the same distance when the shielding member is in the shielding position.

8. An optical scanning device according to claim 7, wherein the first optical path passes through an upper side of the shielding wall with respect to a vertical direction and the second optical path passes through a lower side of the shielding wall with respect to the vertical direction.

9. An optical scanning device according to claim 5, wherein the casing includes a first restricting wall and a second restricting wall configured to restrict movement of the shielding member to the axial direction of the rotating shaft to the shielding member.

10. An optical scanning device according to claim 9, wherein the shielding member is restricted from moving to the axial direction of the rotating shaft to the shielding member by sandwiching the first restricting wall and the second restricting wall by the shielding wall of the shielding member and the restricting wall.

11. An optical scanning device according to claim 5, further comprising a lid configured to close an opening of the casing,
wherein the shielding member is restricted from moving to a vertical direction by the lid.

12. An image forming apparatus comprising:
an optical scanning device according to claim 1;
a plurality of image bearing members as scanned members; and
a developing means configured to develop electrostatic latent images formed on the plurality of image bearing members with toner.

13. An image forming apparatus according to claim 12, further comprising a door configured to be an open state to access inside of the image forming apparatus and a closed state during image formation,
wherein the shielding member becomes the shielding position when the door is in the open state and becomes the retracted position when the door is in the closed state.

14. An image forming apparatus comprising:
an optical scanning device according to claim 5;
a plurality of image bearing members as scanned members; and
a developing means configured to develop electrostatic latent images formed on the plurality of image bearing members with toner.

15. An image forming apparatus according to claim 14, wherein the restricting wall includes a boss portion,
wherein the image forming apparatus includes a door configured to be an open state to access inside of the image forming apparatus and a closed state during image formation, and a moving member configured to move in interrelation with opening and closing of the door,
wherein the moving member rotates the shielding member by moving the boss portion, and
wherein the shielding member becomes the shielding position when the door is in the open state and becomes the retracted position when the door is in the closed state.
